(19) United States
(12) Patent Application Publication
(10) Pub. No.: US 2017/0034305 A1
(43) Pub. Date: Feb. 2, 2017

(54) MANAGING OVERLAPPING TAXONOMIES

(71) Applicant: LinkedIn Corporation, Mountain View, CA (US)

(72) Inventors: Andrew David Blevins, Redwood City, CA (US); Ada Cheuk Ying Yu, Santa Clara, CA (US); Fan Yang, Redwood City, CA (US)

(21) Appl. No.: 14/814,227

(22) Filed: Jul. 30, 2015

(51) Int. Cl. H04L 29/08

(52) U.S. Cl. CPC H04L 67/34; H04L 67/306

(57) ABSTRACT

Systems and methods for managing overlapping taxonomies, in accordance with some embodiments, are disclosed. The system stories a set of taxonomic grouping rules for organizing members based on stored member data and receives a request for grouping information for a particular member. Using stored member data for the particular member, the system classifies the particular member into an atomic taxonomic group in the plurality of the atomic taxonomic groups. The system, based on the atomic taxonomic group that the particular member is classified into, automatically determines the requested grouping information. The system then transmits the requested grouping information to a requesting computer system.

### CROSS-REFERENCE TO RELATED APPLICATIONS

This application claims the benefit of priority to U.S. Provisional Patent Application entitled “Managing Overlapping Taxonomies,” Ser. No. 62/187,136, filed Jun. 30, 2015, which is hereby incorporated herein by reference in its entirety.

### TECHNICAL FIELD

The disclosed example embodiments relate generally to the field of data management, and in particular, to managing taxonomic systems.

### BACKGROUND

The rise of the computer age has resulted in increased access to personalized services online. As the cost of electronics and networking services drops, many services that were previously provided in person are now provided remotely over the Internet. For example, entertainment has increasingly shifted to the online space, with companies such as Netflix and Amazon streaming television shows and movies to members at home. Similarly, electronic mail (e-mail) has reduced the need for letters to be physically delivered. Instead, messages are sent over networked systems almost instantly.

Computer-based online services generate and consequently need to store a huge amount of data. Systems for storing this data can be complicated, especially if the data is frequently used when providing various services. Often, hierarchy-based taxonomies are generated to store data in such a way that useful data can more easily be analyzed and retrieved.

### DESCRIPTION OF THE DRAWINGS

Some example embodiments are illustrated by way of example and not limitation in the figures of the accompanying drawings.

FIG. 1 is a network diagram depicting a client-social networking system environment that includes various functional components of a social networking system, in accordance with some example embodiments.

FIG. 2 is a block diagram illustrating a client system, in accordance with some example embodiments.

FIG. 3 is a block diagram illustrating a social networking system, in accordance with some example embodiments.

FIG. 4A is a diagram representing a particular taxonomic hierarchical data structure, in accordance with some example embodiments.

FIG. 4B is a diagram representing two particular taxonomic hierarchical data structures, in accordance with some example embodiments.

FIG. 4C is a diagram representing two particular taxonomic hierarchical data structures, in accordance with some example embodiments.

FIG. 5 is a block diagram of an exemplary data structure for content item data, in accordance with some example embodiments.

FIG. 6 is a flow diagram illustrating a method, in accordance with some example embodiments, for managing overlapping taxonomies.

FIGS. 7A and 7B is a flow diagram illustrating a method, in accordance with some example embodiments, for managing overlapping taxonomies.

FIG. 8 is a block diagram illustrating an architecture of software, which may be installed on any of one or more devices, in accordance with some example embodiments.

FIG. 9 is a block diagram illustrating components of a machine, according to some example embodiments.

Like reference numerals refer to corresponding parts throughout the drawings.

### DETAILED DESCRIPTION

The present disclosure describes methods, systems, and computer program products for managing overlapping taxonomies. In the following description, for purposes of explanation, numerous specific details are set forth to provide a thorough understanding of the various aspects of different example embodiments. It will be evident, however, to one skilled in the art, that any particular example embodiment may be practiced without all of the specific details, and/or with variations, permutations, and combinations of the various features and elements described herein.

One way that social networks improve the services they offer to members is by storing important information about those members (e.g., information that the members submit to the social network) and using that information to improve the member experience. For example, a member may input the place that they live as part of the social network registration process. The social network stores this information and then uses it to identify information, offers, other members, and so on that may be of interest to a member living at that location.

Data stored for members can be classified (e.g., grouped) into taxonomic groups that are arranged in a hierarchical structure. For example, a member lives in San Jose, Calif., in a particular ZIP code. A taxonomic data grouping system would include the member in a group with other members in that ZIP code. Different taxonomic classification schemes can be used to group members differently depending on what aspect of the members is needed for a particular use case. For example, when grouping animals, a wolf and a deer might be classified together as quadrupeds if the information of interest was method of locomotion. However, the wolf and deer would be classified into separate groups of carnivore and herbivore if the information of interest was eating habits. Similarly, members can be classified based on location, work experience, job title, education, and so on, depending on the informational needs of the social networking system.

In some example embodiments, the member is assigned to a particular taxonomic group based on the city, the ZIP code, or a combination of both. Based on the ZIP code/city grouping, the member can then be assigned to higher levels of the hierarchy. For example, a taxonomic hierarchy can group data such that each member is grouped into a particular city group, each city group is grouped into a metro area group, and each metro area group is grouped into a state group. Thus, if the next level of the hierarchy is metro area, the social networking system can automatically assign a member who is already grouped into the “Redwood City” city group to the Bay Area metro area group. Similarly, the member is then assigned to the California state group (because the Bay Area metro area group is associated with (as a child node) the California state group in the taxonomic hierarchy).

Thus, a hierarchical taxonomic structure can be seen as a tree, and each group defined by the taxonomy is a node in that tree. In some example embodiments, the graph is a strict tree, such that each node in the tree (e.g., a group in the taxonomy) has at most one parent node (e.g., a group within which it is included) and terminates in a series of atomic nodes. In other example embodiments, a particular node (or group) can have multiple parents, so long as the taxonomic graph is guaranteed to have no cycles (e.g., following a child node to parent nodes can never lead you back to the child node).

In some example embodiments, the social networking system creates a lowest level of a hierarchy such that the lowest taxonomic groupings are a series of taxonomic atoms. Taxonomic atoms are taxonomic groupings defined such that there is no member overlap between them. Thus, a member can be grouped into only one taxonomic atom for a given taxonomic hierarchical structure. For example, if a given taxonomic grouping seeks to group members based on their jobs, the atomic level may be job description. However, in the case that job description alone creates overlaps, the atomic level of the hierarchy could be created based on a tuple including job description and the department within the organization for which a member works. Each atomic grouping is then associated with one or more groups in higher levels of the taxonomic hierarchy.

In some example embodiments, the social networking system needs to analyze the member data in a new way or for a new application. As such, the social networking system receives a set of custom taxonomic groupings and the hierarchical relationship information that describes how the custom taxonomic groupings are related. In some example embodiments, the custom taxonomic groups are associated with one or more groups of an existing data group. In this way, the custom taxonomic groups are able to quickly organize all the member data under the new grouping by associating the older taxonomic groups with the new groups (e.g., starting with the atomic level groups).

The social networking system can then receive a request for information for a particular member. For example, a custom taxonomic grouping classifies regions in Europe based on the language most commonly spoken in each region. Each city (or section of a city) exists as an atomic group in this hierarchy. Once a member has been classified (based on stored member data) into a particular city group, the member can then be associated with a region (wherein region groups can be defined to include multiple city groups). Each region group can then be associated with a particular language area (wherein each language area group is associated with a particular language most commonly used in the area). Thus, once a member can be grouped into a specific city group, the social networking system automatically determines the language most likely spoken by the member.

Once the taxonomic structure is in place, the social networking system can leverage the atomic groupings to enable custom taxonomic groupings to be determined. For example, once the above language classification is in place, the social networking system receives custom taxonomic rules to group the members by country of residence. The custom taxonomic rules determine which country a member is a resident of based on the region group the member is included in. Thus, the existing region groups are associated with particular countries (assuming, for this example, that each region exists in only one country) and the current region group for Member A is used to quickly and easily determine which country group Member A belongs in.

The classification step that originally placed Member A into a particular city group (assuming city groups are the atomic-level groups in this example) does not need to be repeated. Thus, this determination is quick and efficient. If a region somehow changes country (e.g., the Crimea region going from Ukraine to Russia), only the rules associating that region with a country need be changed. Once the rule has been changed, the member will automatically be associated with the new country.

In some example embodiments, the social networking system can determine whether two taxonomic groups have any overlapping data by identifying each atomic group associated with a first group and a second group, by identifying all groups underneath the first group and the second group until the lowest taxonomic level is reached (e.g., the atomic group level). The social networking system compares the list of atomic groups associated with the first taxonomic group and the list of atomic groups associated with the second taxonomic group. If any of the atomic groups are included in both lists, the social networking system determines that the first taxonomic group and the second taxonomic group have overlap.

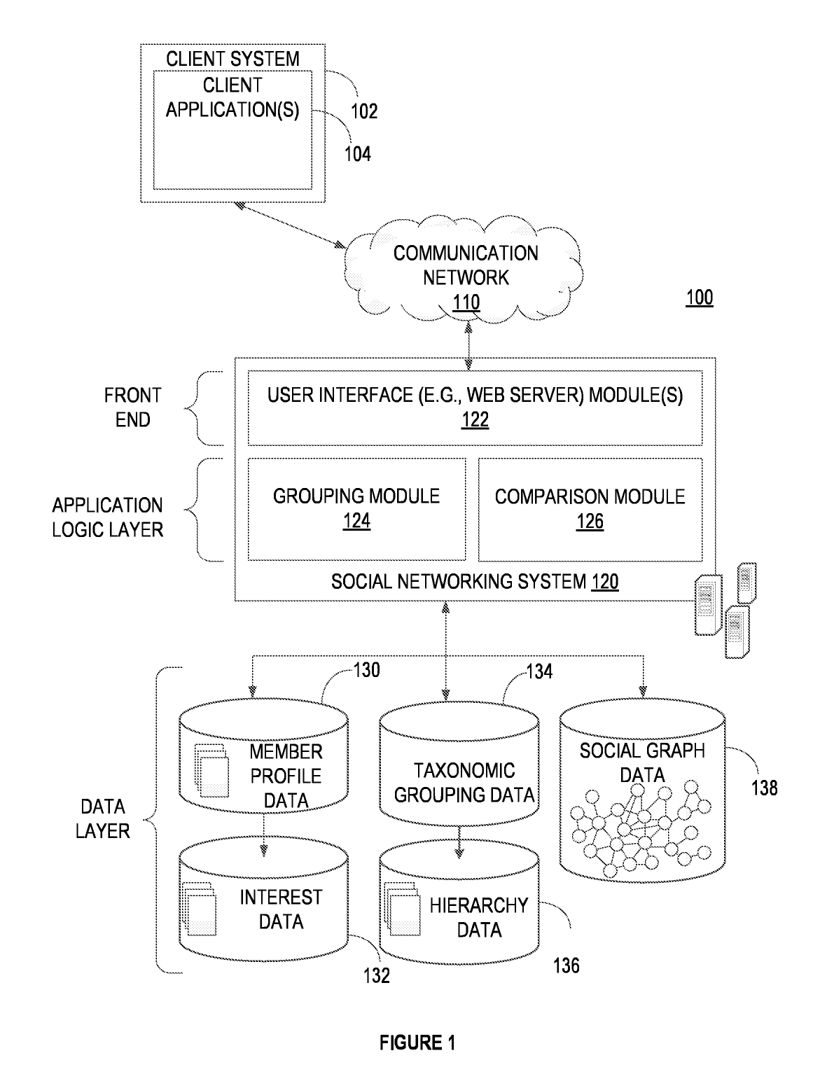

FIG. 1 is a network diagram depicting a client-social networking system environment 100 that includes various functional components of a social networking system 120, in accordance with some example embodiments. The client-social networking system environment 100 includes one or more client systems 102, and the social networking system 120. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some example embodiments, a client system 102 is an electronic device, such as a personal computer (PC), a laptop, a smartphone, a tablet, a mobile phone, or any other electronic device capable of communication with a communication network 110. The client system 102 includes one or more client applications 104, which are executed by the client system 102. In some example embodiments, the client application(s) 104 include one or more applications from a set consisting of search applications, communication applications, productivity applications, game applications, word processing applications, or any other useful applications. The client application(s) 104 include a web browser. The client system 102 uses a web browser to communicate with the social networking system 120 and to display information received from the social networking system 120.

In some example embodiments, the client system 102 includes an application specifically customized for communication with the social networking system 120 (e.g., a LinkedIn iPhone application). In some example embodiments, the social networking system 120 is a server system that is associated with a social networking service. However, the social networking system 120 and the server system that actually provides the social networking service may be completely distinct computer systems.

In some example embodiments, the client system 102 sends a request to the social networking system 120 for a webpage associated with the social networking system 120. For example, a member uses the client system 102 to log into the social networking system 120 and clicks a link to send a request to the social networking system 120 for information about a content item on a social networking webpage. In response, the client system 102 receives the requested data (e.g., a blog post and associated comments) and displays them on the client system 102.

In some example embodiments, as shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various example embodiments have been omitted from FIG. 1. However, a skilled artisan will readily recognize that various additional functional modules and engines may be used with a social networking system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although the social networking system 120 is depicted in FIG. 1 as having a three-tiered architecture, the various example embodiments are by no means limited to this architecture.

As shown in FIG. 1, the front end consists of a user interface module (e.g., a web server) 122, which receives requests from various client systems 102 and communicates appropriate responses to the requesting client systems 102. For example, the user interface module(s) 122 may receive requests in the form of Hypertext Transport Protocol (HTTP) requests, or other web-based, application programming interface (API) requests. The client system 102 may be executing conventional web browser applications or applications that have been developed for a specific platform to include any of a wide variety of mobile devices and operating systems.

As shown in FIG. 1, the data layer includes several databases, including databases for storing data for various members of the social networking system 120, including member profile data 130, interest data 132 (e.g., data describing the interests of one or more members of the social networking system 120), taxonomic grouping data 134 (e.g., data describing how the member profile data 130, interest data 132, or social graph data 138 is organized (or classified) into groups for various purposes), hierarchy data 136 (e.g., data that describes the hierarchy within which the taxonomic groups exist, including the relationships between various groups as parent or child nodes and so on), and social graph data 138 (e.g., data stored in a particular type of database that uses graph structures with nodes, edges, and properties to represent and store the data). Of course, in various alternative example embodiments, any number of other entities might be included in the social graph (e.g., companies, organizations, schools and universities, religious groups, non-profit organizations, governmental organizations, non-government organizations (NGOs), and any other group) and, as such, various other databases may be used to store data corresponding with the other entities.

Consistent with some example embodiments, when a person initially registers to become a member of the social networking system 120, the person will be prompted to provide some personal information, such as his or her name, age (e.g., birth date), gender, contact information, home town, address, educational background (e.g., schools, majors, etc.), current job title, job description, industry, employment history, skills, professional organizations, memberships with other online service systems, and so on. This information is stored, for example, in the member profile data 130.

In some example embodiments, the member profile data 130 includes the interest data 132. In other example embodiments, the interest data 132 is distinct from, but associated with, the member profile data 130. The interest data 132 stores data detailing one or more interests for members of the social networking system 120, including topics of interest to the member, hobbies, sports teams, companies, technology products, non-government organizations, search history, likes, follows, content rating, and so on. In some example embodiments, this information is only tracked with member permission.

The taxonomic grouping data 134 includes all data needed to group various types of data (e.g., data included in the member profile data 130) in accordance with the various services offered by the social networking system 120. For example, a recruiting service organizes members based on the specific university degree that a member has and the university from which the degree was obtained. In some example embodiments, the members can be grouped into atomic-level groups (groups with no overlap) based on a tuple including the university attended and the degree received.

In some example embodiments, the hierarchy data 136 stores data indicating the hierarchical relationships between various taxonomic groups (e.g., defined by the taxonomic grouping data 134). For example, taxonomic groups for location may be organized ZIP code->city->area->state->country. The hierarchy data 136 stores data indicating which ZIP codes are included in each city, which cities are included in each area, which areas are included in each state, and which states are included in each country. Thus, by knowing the ZIP code for a member, the social networking system 120 can determine which groups higher in the hierarchy the member fits into.

Once registered, a member may invite other members, or be invited by other members, to connect via the social network service. A “connection” may include a bilateral agreement by the members, such that both members acknowledge the establishment of the connection. Similarly, in some example embodiments, a member may elect to “follow” another member. In contrast to establishing a “connection,” the concept of “following” another member typically is a unilateral operation and, at least in some example embodiments, does not include acknowledgement or approval by the member that is being followed. When one member follows another, the member who is following may receive automatic notifications about various activities undertaken by the member being followed. In addition to following another member, a member may elect to follow a company, a topic, a conversation, or some other entity, which may or may not be included in the social graph. Various other types of relationships may exist between different entities and are represented in the social graph data 138.

The social networking system 120 may provide a broad range of other applications and services that allow members the opportunity to share and receive information, often customized to the interests of the member. In some example embodiments, the social networking service may include a photo sharing application that allows members to upload and share photos with other members. As such, at least in some example embodiments, a photograph may be a property or entity included within a social graph. In some example embodiments, members of a social networking service may be able to self-organize into groups, or interest groups, organized around subject matter or a topic of interest. In some example embodiments, the data for a group may be stored in a database. When a member joins a group, his or her membership in the group will be reflected in the organization activity data, the member activity data, and the social graph data 138.

In some example embodiments, the application logic layer includes various application server modules, which, in conjunction with the user interface module(s) 122, generate various user interfaces (e.g., web pages) with data retrieved from various data sources in the data layer. In some example embodiments, individual application server modules are used to implement the functionality associated with various applications, services, and features of the social networking service. For instance, a messaging application, such as an email application, an instant messaging application, or some hybrid or variation of the two, may be implemented with one or more application server modules. Similarly, a search engine enabling members to search for and browse member profiles may be implemented with one or more application server modules. Of course, other applications or services that utilize a grouping module 124 or a comparison module 126 may be separately implemented in their own application server modules.

In addition to the various application server modules, the application logic layer includes a grouping module 124 and/or a comparison module 126. As illustrated in FIG. 1, in some example embodiments, the grouping module 124 or the comparison module 126 are implemented as services that operate in conjunction with various application server modules. For instance, any number of individual application server modules can invoke the functionality of the grouping module 124 or the comparison module 126. However, in various alternative example embodiments, the grouping module 124 and the comparison module 126 may be implemented as their own application server modules such that they operate as stand-alone applications. In some example embodiments, the grouping module 124 or the comparison module 126 include or have an associated publicly available API that enables third-party applications to invoke the functionality they provide.

Generally, the grouping module 124 conducts an analysis of various data stored in the member profile data 130, the interest data 132, and the social graph data 138 to group members of the social networking system 120 into useful taxonomical groups. In some example embodiments, the grouping module 124 uses a classifier (e.g., a naïve Bayes classifier) to sort members into the appropriate taxonomical groups or generates likelihoods that a member belongs in a particular group. For example, the social networking system 120 classifies members into groups based on their occupation.

In some example embodiments, the grouping module 124 only classifies members into the lowest-level grouping in a taxonomic data structure (e.g., the atomic-level groups). Once a member is classified into a particular atomic grouping, the grouping module 124 is able to determine the appropriate groups for higher level of the taxonomic hierarchy. Indeed, as customized taxonomical groupings are added, the grouping module 124 can automatically determine which groups a particular member fits into, based on the specific atomic group in which the member is grouped.

In some example embodiments, the grouping module 124 determines a likelihood that a member should be grouped into one or more atomic groupings. For example, the grouping module 124 determines that Member A has a 30 percent likelihood of being in Atomic Group 1, a 60 percent likelihood of being in Atomic Group 2, and a 10 percent likelihood of being in Atomic group 3.

Once these likelihoods are determined for the atomic-level groupings, likelihoods for higher hierarchical levels can be determined. Continuing the above example, if Atomic Group 1 and Atomic Group 3 are child nodes of Upper Group 5, and Atomic Group 2 is a child node of Upper Group 6, then Member A has a 40 percent likelihood of being in Upper Group 5 (e.g., by adding the likelihood of being in Atomic Group 1 and Atomic Group 3) and a 60 percent likelihood of being in Upper Group 6.

In another example, using the member's current work title, previous work history, education, social networks, and so, the social networking system 120 determines that Member A has an 85 percent chance of being a Java programmer, a 12 percent chance of being a Javascript programmer, and a 3 percent chance of being a Python programmer. Each group is associated with a more general category higher up the hierarchy, and the likelihood of Member A being in each more general category can be determined by adding the probabilities of the subgroups that are included in the more general category. Thus, in the above example, Member A has an 88 percent chance of being in the application programmer group (of which the Java programmer and the Python programmer groups are subgroups) and a 12 percent chance of being in the front-end programmer group (which includes the Javascript programmer group as a subgroup).

In some example embodiments, the comparison module 126 compares the members in two different taxonomical groups within the same hierarchy to determine whether there are any overlapping members between the first taxonomical group and the second taxonomical group. This is accomplished by traversing down the hierarchical graph and determining each subgroup included in the first taxonomical group and the second taxonomical group.

Once atomic groups found in the lowest layer of the hierarchical structure are determined (e.g., the layer in the hierarchy without any sublayers) the comparison module 126 records each atomic group (e.g., the most narrow/basic grouping in the particular hierarchical grouping) included in the first taxonomical group and the second taxonomical group. The comparison module 126 then compares the list of atomic groups for each of the first taxonomical group and the second taxonomical group. If the two lists have any atomic groups in common, the first taxonomical group and the second taxonomical group have overlap.

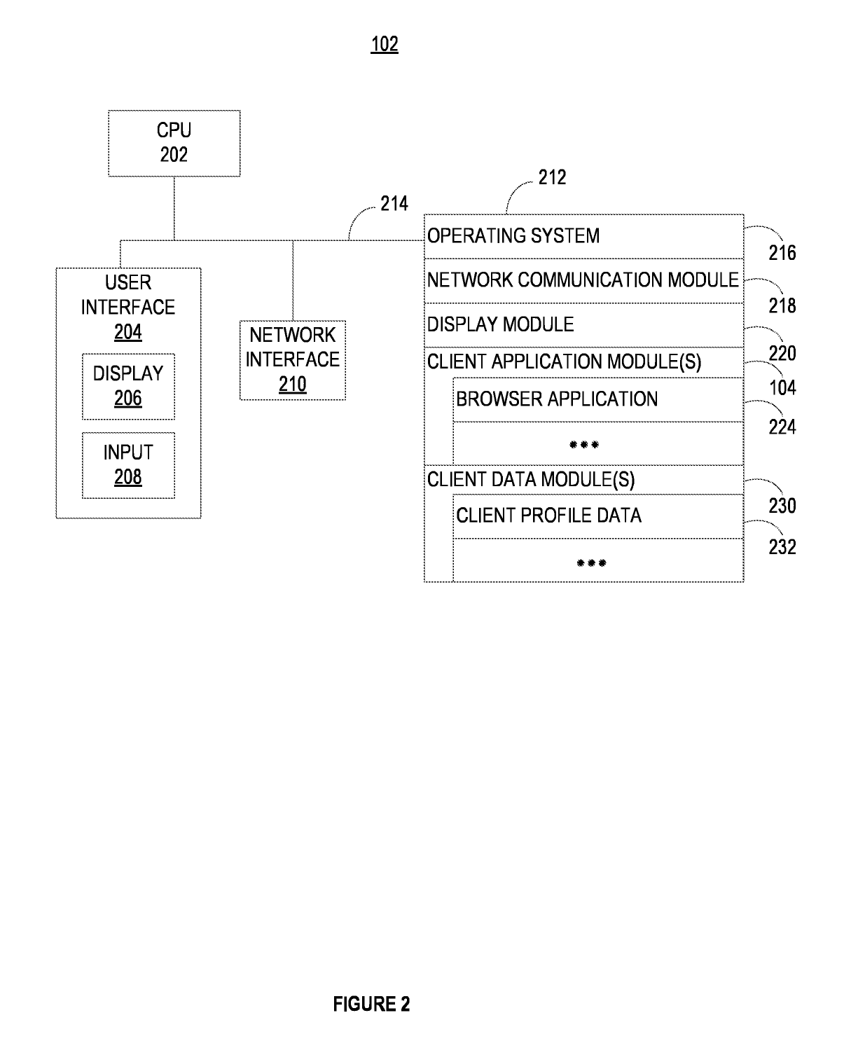

FIG. 2 is a block diagram further illustrating the client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input means 208 such as a keyboard, a mouse, a touch sensitive display, or other input means 208. Furthermore, some client systems 102 use a microphone and voice recognition to supplement or replace the keyboard.

The memory 212 includes high-speed random access memory, such as dynamic random-access memory (DRAM), static random access memory (SRAM), double data rate random access memory (DDR RAM), or other random access solid state memory devices, and may include non-volatile memory, such as one or more magnetic disk storage devices, optical disk storage devices, flash memory devices, or other non-volatile solid state storage devices. The memory 212 may optionally include one or more storage devices remotely located from the CPU(s) 202. The memory 212, or alternatively the non-volatile memory device(s) within the memory 212, comprise(s) a non-transitory computer-readable storage medium.

In some example embodiments, the memory 212, or the computer-readable storage medium of the memory 212, stores the following programs, modules, and data structures, or a subset thereof:
an operating system 216 that includes procedures for handling various basic system services and for performing hardware-dependent tasks;
a network communication module 218 that is used for connecting the client system 102 to other computers via the one or more communication network interfaces 210 (wired or wireless) and one or more communication networks 110, such as the Internet, other WANs, LANs, metropolitan area networks (MANs), etc.;
a display module 220 for enabling the information generated by the operating system 216 and client application(s) 104 to be presented visually on the display device 206;
one or more client applications 104 for handling various aspects of interacting with the social networking system 120 (FIG. 1), including but not limited to:
   a browser application 224 for requesting information from the social networking system 120 (e.g., product pages and member information) and receiving responses from the social networking system 120; and
client data module(s) 230 for storing data relevant to the clients, including but not limited to:
   client profile data 232 for storing profile data related to a member of the social networking system 120 associated with the client system 102.

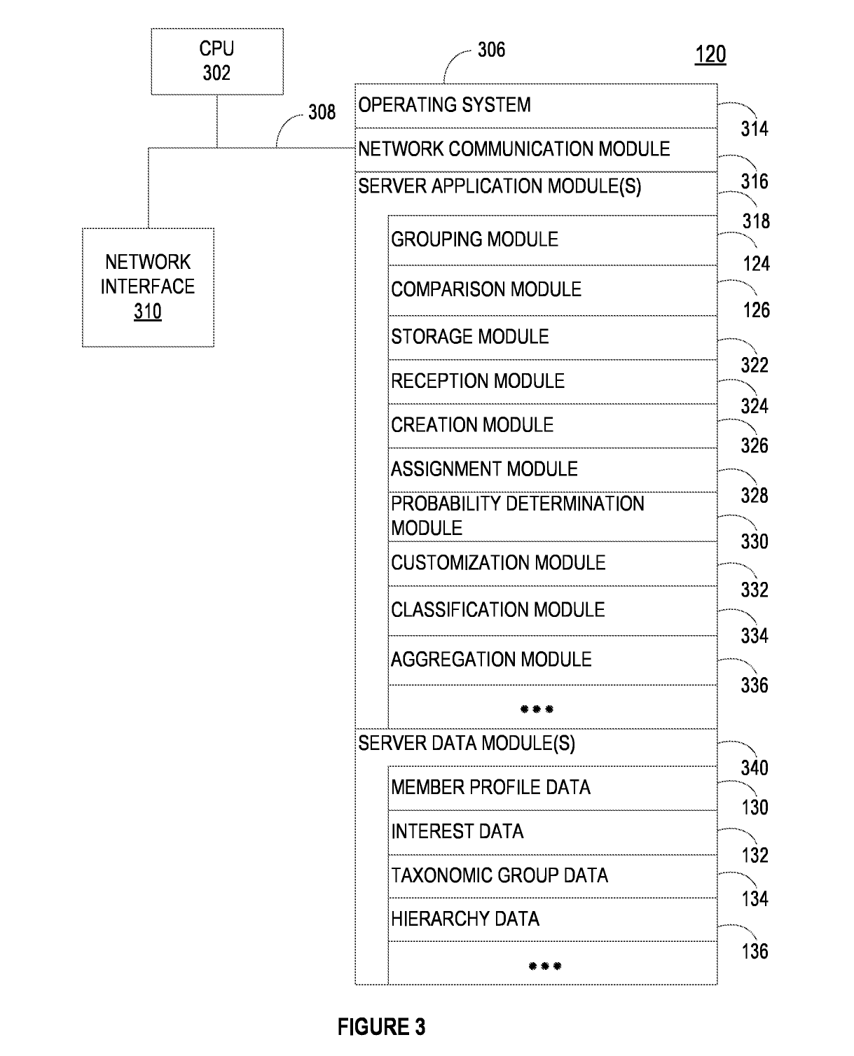

FIG. 3 is a block diagram further illustrating the social networking system 120, in accordance with some example embodiments. The social networking system 120 typically includes one or more CPUs 302, one or more network interfaces 310, memory 306, and one or more communication buses 308 for interconnecting these components. The memory 306 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. The memory 306 may optionally include one or more storage devices remotely located from the CPU(s) 302.

The memory 306, or alternatively the non-volatile memory device(s) within the memory 306, comprises a non-transitory computer-readable storage medium. In some example embodiments, the memory 306, or the computer-readable storage medium of the memory 306, stores the following programs, modules, and data structures, or a subset thereof:
an operating system 314 that includes procedures for handling various basic system services and for performing hardware-dependent tasks;
a network communication module 316 that is used for connecting the social networking system 120 to other computers via the one or more communication network interfaces 310 (wired or wireless) and one or more communication networks 110, such as the Internet, other WANs, LANs, MANs, and so on;
one or more server application modules 318 for performing the services offered by the social networking system 120, including but not limited to:
   a grouping module 124 for using data associated with members of the social networking system 120 to group members based on the data and specific criteria (e.g., customizing content on a website, identifying members suited to a particular offer, and so on);
   a comparison module 126 for comparing the users associated with two different taxonomic groups (e.g., two groups with different associated characteristics) to determine whether the two groups have any overlapping members (e.g., members that appear in both groups);
   a storage module 322 for storing data associated with members, taxonomic grouping data 134 (e.g., rules for grouping members based on one or more rules, and group hierarchy rules);
   a reception module 324 for receiving a request to set up a set of customized taxonomic groupings, wherein customized taxonomic groupings establish new taxonomic groupings for data associated with members and establish relationships with at least some of the existing taxonomic structure;
   a creation module 326 for generating new taxonomic groupings (especially atomic groups that are the lowest-level groups in the taxonomic structure and that have no overlapping users between atomic groups) such that the new taxonomic groupings have no overlapping members;
   an assignment module 328 for assigning members to specific taxonomic groups based on the data associated with those members;
   a probability determination module 330 for determining the likelihood that a member should be grouped into a particular atomic group (e.g., 80% to group A, 15% to group B, and 5% to group C);
   a customization module 332 for receiving and implementing customized taxonomic grouping instructions;
   a classification module 334 for assigning lower-level taxonomic groups to their corresponding higher-level (or parent) taxonomic groups; and
   an aggregation module 336 for determining the likelihood that a member should be assigned to a particular group in a taxonomic data structure by aggregating the previously determined likelihoods that the member belongs to one of the group's subgroups (e.g., groups that are lower than the particular group in the hierarchy and are considered to be components of the higher-level group, such as city groups within a state group); and
server data module(s) 340, holding data related to the social networking system 120, including but not limited to:
   member profile data 130, including both data provided by the member, who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on member activity, social graph data, overall trend data for the social networking system 120, and so on;
   interest data 132, including data representing a member's stated or inferred interest in one or more topics;
   taxonomic grouping data 134, including data for describing how members should be sorted into one or more taxonomic data structures based on the data associated with each member; and
   hierarchy data 136, including data describing how every group in a specific taxonomic data structure is related to each other group, including which groups are children/parents of other groups, the relative level of each group in the hierarchy, and so on.

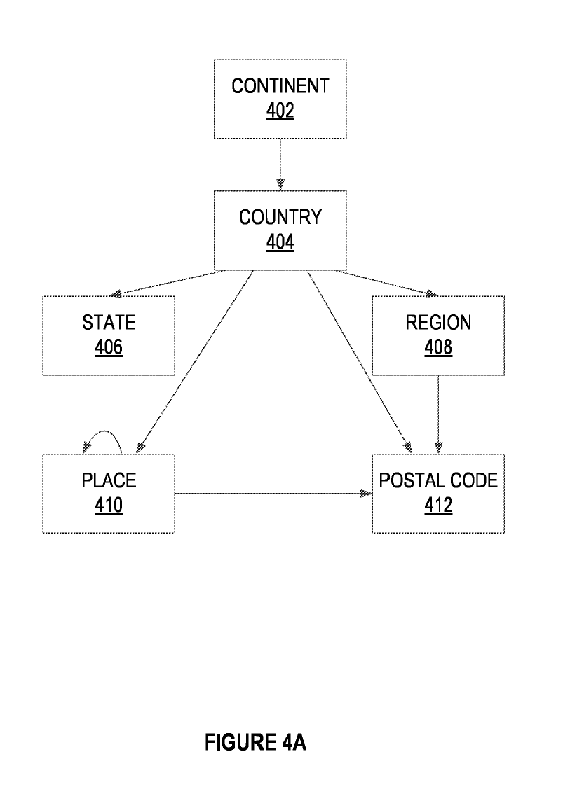

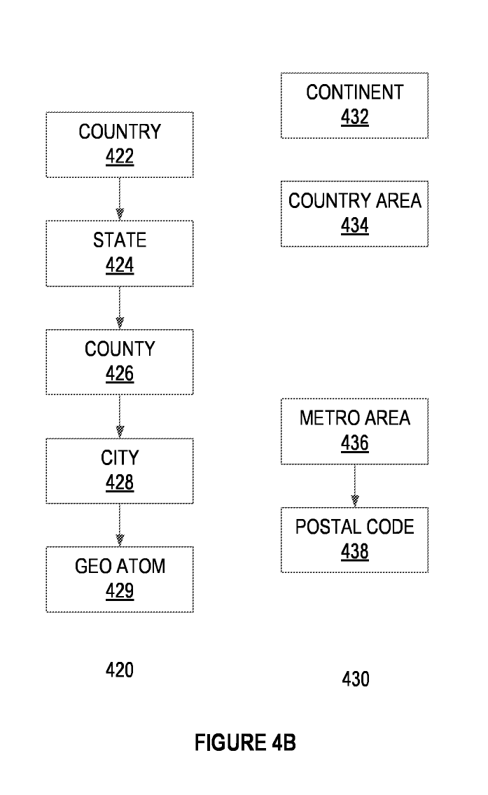

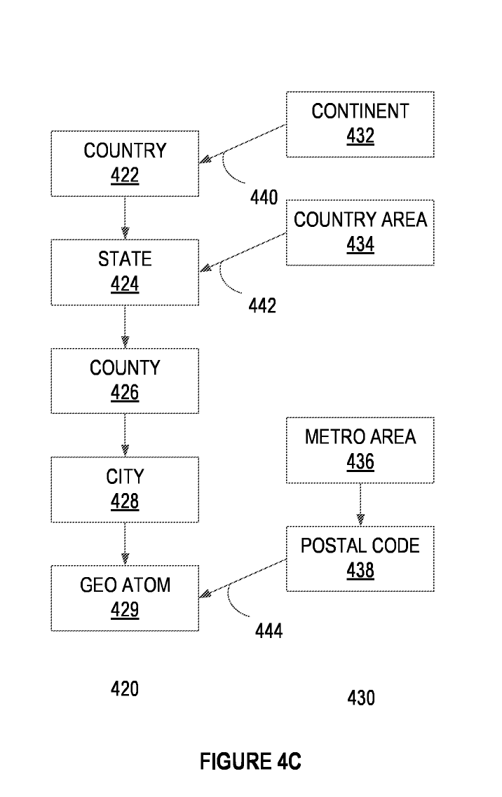

FIG. 4A is a diagram representing a particular taxonomic hierarchical data structure, in accordance with some example embodiments. The displayed taxonomic hierarchical data structure 400 is an example that can be used but includes many flaws.

In this example embodiment, the taxonomic hierarchical data structure 400 includes six different hierarchical group types, each with relationships with at least one other group type: a continents group 402 (includes seven groups, one for each continent), a country group 404 (e.g., one group for each possible country), a state group 406 (e.g., each state has a unique group), a region group 408 (e.g., groups include well-known geographic regions like the Rockies or the Bay Area), a place group 410 (e.g., any group based on a geographic location could be allowed as a place group), and a postal code group 412 (e.g., groups based on the areas covered by specific postal codes).

Each group type is connected to at least one other group type. For example, each continent group 402 is associated with one or more country groups 404 depending on which continent the country is located in. Similarly, each state group 406 is associated with a particular country group 404 based on which country the state is located in. Region groups 408 cannot always be associated with particular states, so no reliable state-region mapping can occur, and instead region groups 408 are also mapped to their respective country groups 404.

Place groups 410 can be associated with countries and with other place groups 410 (e.g., a store can be associated with a mall that it is in). Finally, postal code groups 412 can be associated with places, regions, countries, and potentially (although not shown here) with states. However, a postal code may have more than one place within it, making it possible for a postal code group 412 to be associated with multiple different place groups 410.

This example of a taxonomic hierarchical data structure 400 has many flaws. Many group types are not related at all, such that knowing which group a member fits into for one group type or level will not help the social networking system (e.g., system 120 in FIG. 1) determine which group the member should be included in for another group type. In addition, because lower-level groups can be associated with multiple parent groups of a particular group type, (e.g., a postal code can cross state boundaries), even when group types are connected in a formal way, the social networking system (e.g., system 120 in FIG. 1) still might not be able to group a member correctly into a higher-level group based on which group they are included in at a lower level.

FIG. 4B is a diagram representing two particular taxonomic hierarchical data structures, in accordance with some example embodiments. The two particular taxonomic hierarchical data structures include a standard geographical data structure 420 for a given system and several custom taxonomic group types 430.

The standard geographical data structure 420 includes five group types, all arranged in a strict hierarchy. Thus, each geo atom group 429 is associated with only a single city group 428. Each city group 428 is associated with a single county group 426. Each county group 426 is associated with only a single state group 424, and each state group is associated with a single country group 422.

In this way, knowing any group which a particular member is sorted into allows the social networking system (e.g., system 120 in FIG. 1) to automatically determine appropriate groups for all the hierarchical levels above that group. As such, once a member is grouped into a geo atom group 429, all other grouping tasks can be accomplished nearly instantly. In some example embodiments, a geo atom group 429 is an atomic group type, wherein atomic group types are generated such that there is no ambiguity or overlap between them. For example, to create an atomic type group in the geographical data structure 420, the social networking system (e.g., system 120 in FIG. 1) creates a tuple identifier consisting of the postal code and the city. Thus, there is no overlap between any pair of geo atom groups 429, and members can be sorted into the appropriate atomic group with confidence.

However, as new services and algorithms are produced by the social networking system (e.g., system 120 in FIG. 1), new types of information are needed. The easy way to use the existing taxonomic data structure to find the needed information is to create one or more custom taxonomic group types 430. In this example, the custom taxonomic group types 430 include continent groups 432, country area groups 434, metro area groups 436, and postal code groups 438. New custom taxonomic group types 430 need not be associated with each other (e.g., the continent groups 432 are not associated with the country area groups 434). However, it is possible for the custom taxonomic group types 430 to have explicit relationships with each other, such as postal code groups 438 being associated with particular metro area groups 436.

FIG. 4C is a diagram representing two particular taxonomic hierarchical data structures, in accordance with some example embodiments. The two particular taxonomic hierarchical data structures include a standard geographical data structure 420 for a given system and several custom taxonomic group types 430. This particular embodiment also includes one or more relationships between the custom groupings or group types and the existing group types.

In some example embodiments, when a new custom grouping is received, it also includes data that describes how that custom grouping should be fit into the existing hierarchical taxonomic data structure. For example, the new continent group 432 includes data 440 describing which country groups 422 are associated with which continent groups. Similarly, country area groups 434 include data 442 describing which state groups 424 are associated with particular country area groups 434.

In other examples, the metro area group 436 does not have any explicit data linking it to existing taxonomical groups. However, the metro area groups 436 include data describing which postal code groups 438 are associated with each metro area group 436. The postal code groups 438 include data 444 describing which geo atom groups 429 are associated with each postal code. Thus, the metro area groups 436 are still able to tie back to the geo atom groups 429.

In this way, the geo atom groups 429 remain constant (e.g., once a member has been grouped into a specific geo atom group 429, that grouping does not change unless the member moves) and all other custom groupings can be determined by associating the custom group type with any already existing taxonomical group. Thus, members can be grouped in any conceivable way so long as the custom grouping is able to be associated with the atomic level groups.

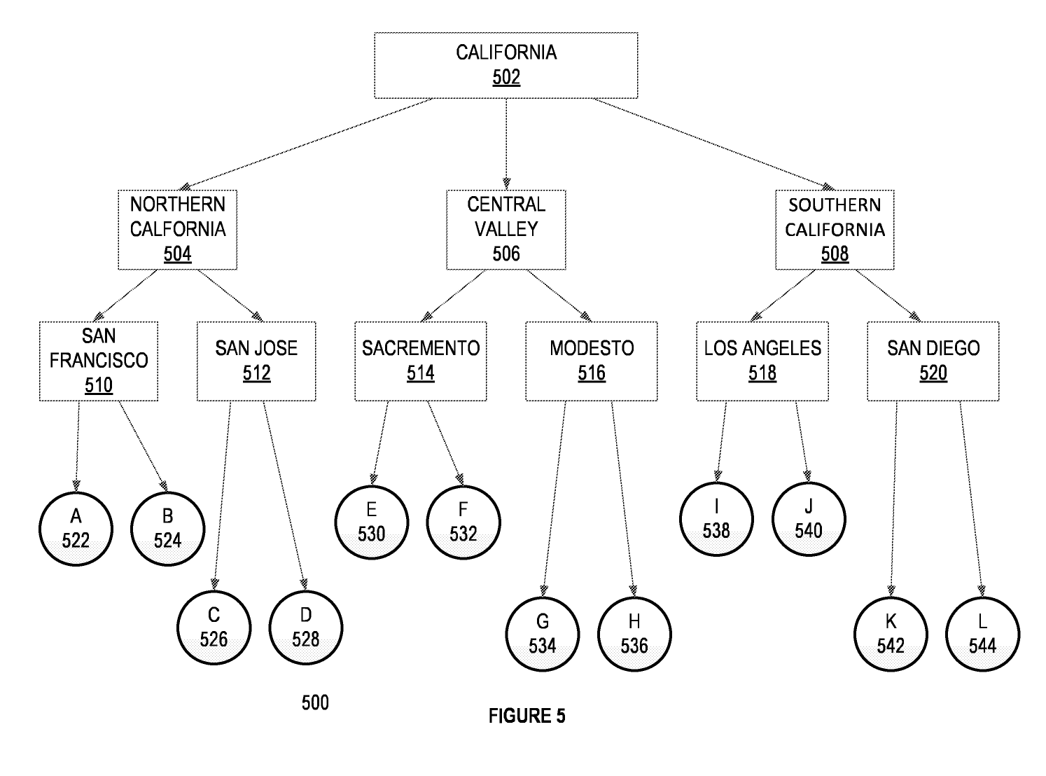

FIG. 5 is a diagram representing a hierarchical taxonomic data graph 500, in accordance with some example embodiments. The hierarchical taxonomic data graph 500 shows the relationships between various taxonomical groups, with parent groups higher and child groups (e.g., groups that can be included in the parent group) lower. Arrows lead from the parent group to the one or more subgroups or child groups that are included in the parent group. In this case, only a select few groups are included for ease of reference because a full diagram of all likely groups would be too large.

In this example, the group that is highest in the hierarchy is the California group 502, representing a state group. There are three direct subgroups: a Northern California subgroup 504, a Central Valley subgroup 506, and a Southern California subgroup 508. Each of these subgroups represents a region of the state of California. Each region-level subgroup, then, has two subgroups, which represent cities within the region. The Northern California subgroup 504 includes a San Francisco subgroup 510 and a San Jose subgroup 512.

The Central Valley subgroup 506 includes two subgroups: a Sacramento subgroup 514 and a Modesto subgroup 516. The Southern California subgroup 508 includes two subgroups: a Los Angeles subgroup 518 and a San Diego subgroup 520.

Each city-level subgroup has one or more subgroups that represent geo atoms. The San Francisco subgroup 510 includes geo atoms A 522 and B 524, the San Jose subgroup 512 includes geo atoms C 526 and D 528, the Sacramento subgroup 514 includes geo atoms E 530 and F 532, the Modesto subgroup 516 includes geo atoms G 534 and H 536, the Los Angeles subgroup 518 includes geo atoms I 538 and J 540, and the San Diego subgroup 520 includes geo atoms K 542 and L 544.

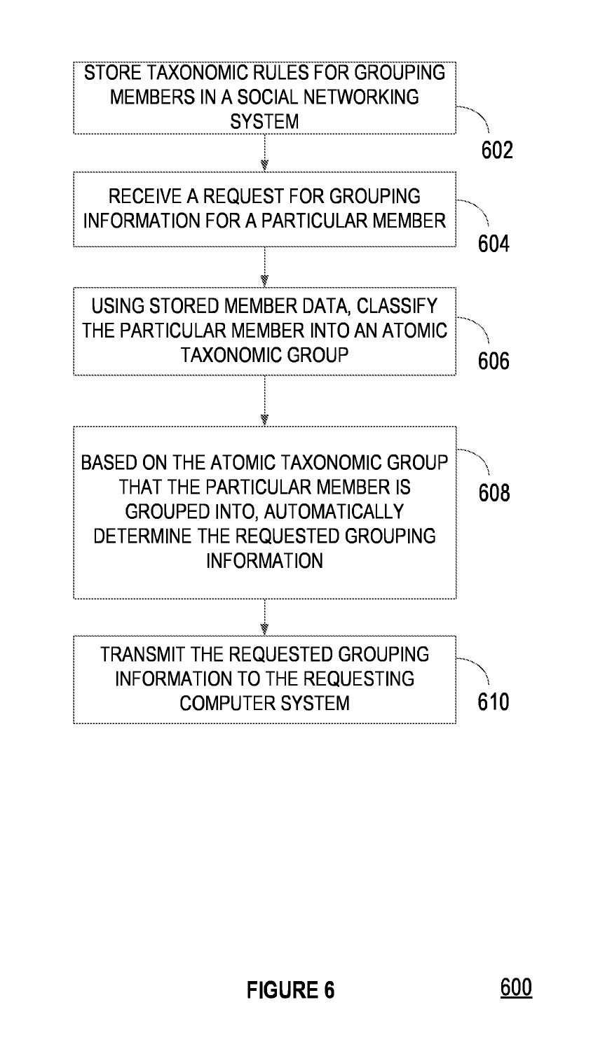

FIG. 6 is a flow diagram illustrating a method 600, in accordance with some example embodiments, for organizing overlapping taxonomies. Each of the operations shown in FIG. 6 may correspond to instructions stored in a computer memory (e.g., memory 306) or a computer-readable storage medium. In some example embodiments, the method 600 described in FIG. 6 is performed by a social networking system (e.g., system 120 in FIG. 1).

In some example embodiments, the method 600 is performed at a social networking system (e.g., system 120 in FIG. 1) including one or more processors and memory 306 storing one or more programs for execution by the one or more processors.

The social networking system (e.g., system 120 in FIG. 1) stores (602) taxonomic rules for grouping members in a social networking system. Taxonomic rules organize members into groups based characteristics of each member for use in various services provided by the social networking system (e.g., system 120 in FIG. 1). For example, the social networking system (e.g., system 120 in FIG. 1) might need to group members based on their occupation, and the taxonomic rules define what those groups should be and how the grouping is accomplished (e.g., the characteristics that would result in a member being grouped in a particular group rather than another group).

The social networking system (e.g., system 120 in FIG. 1) receives (604) a request (from a service within the system or a client system) for grouping information associated with a particular member (e.g., the request defines a particular hierarchical level in the taxonomic structure and requests to know which group the particular member is grouped into). For example, a service provided by the social networking system (e.g., system 120 in FIG. 1) uses country grouping data for members to determine which news items to display to each member and thus requests the country grouping data for a particular member.

The social networking system (e.g., system 120 in FIG. 1) uses stored member data to classify (606) the particular member into an atomic taxonomic group. An atomic taxonomic group is a group in the lowest level of the hierarchical taxonomic structure. In some example embodiments, the atomic taxonomic groups are created such that there is no overlap between these groups. For example, atomic taxonomic groups can be postal codes. However, in some cases postal codes might overlap multiple small towns, so a better atomic taxonomic grouping would use postal codes and small town names to create a tuple value that does not overlap.

Based on the atomic taxonomic group that the particular member is grouped into, the social networking system (e.g., system 120 in FIG. 1) automatically determines (608) the requested grouping information. For example, if the social networking system (e.g., system 120 in FIG. 1) receives a request to determine the technology area that a particular member works in, the member is first grouped based on the specific job role (e.g., python programmer).

In some example embodiments, this initial grouping is performed long before the request is actually made. In other example embodiments, this grouping is done on demand when the request is received. Once the member is grouped into a particular atomic taxonomic group, the social networking system (e.g., system 120 in FIG. 1) determines a parent group with which the atomic taxonomic group is associated. This process is repeated to traverse up the hierarchical structure until the relevant group level is reached.

The social networking system (e.g., system 120 in FIG. 1) transmits (610) the requested grouping information to the requesting computer system.

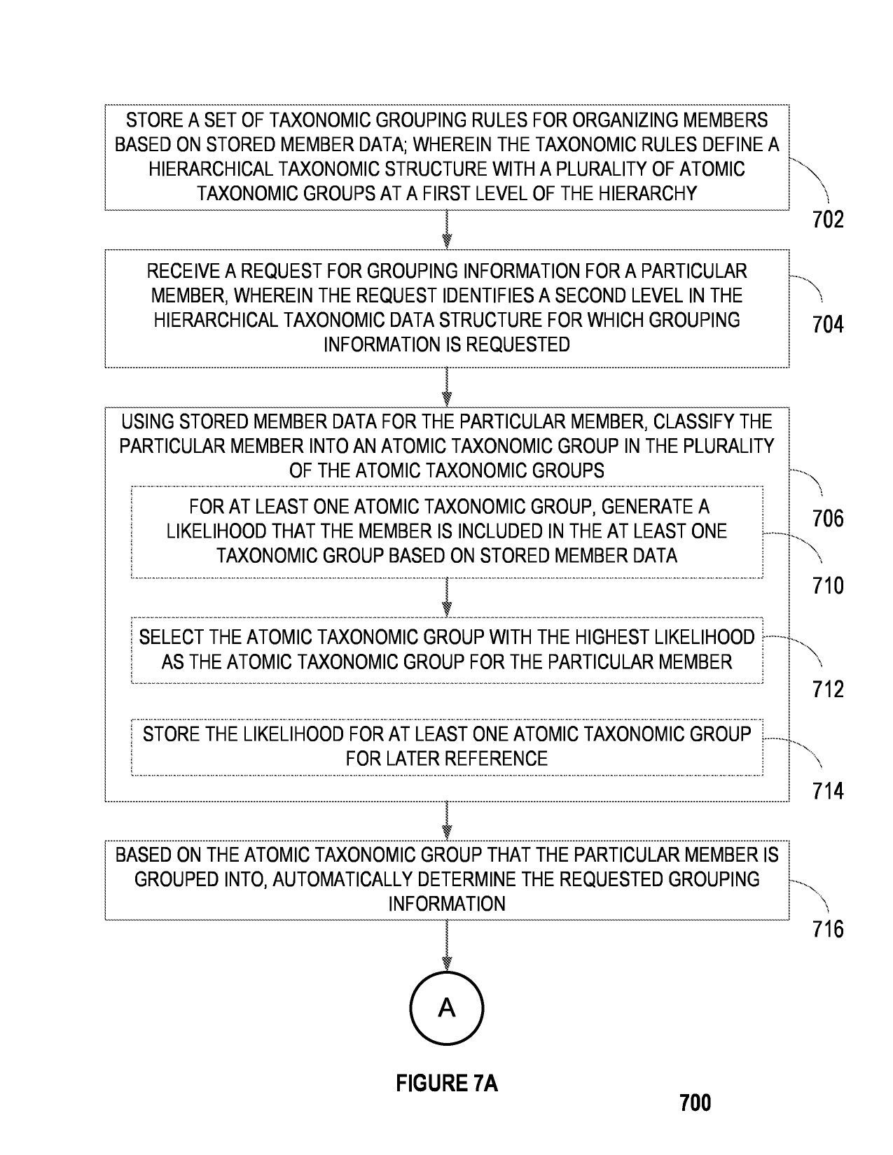

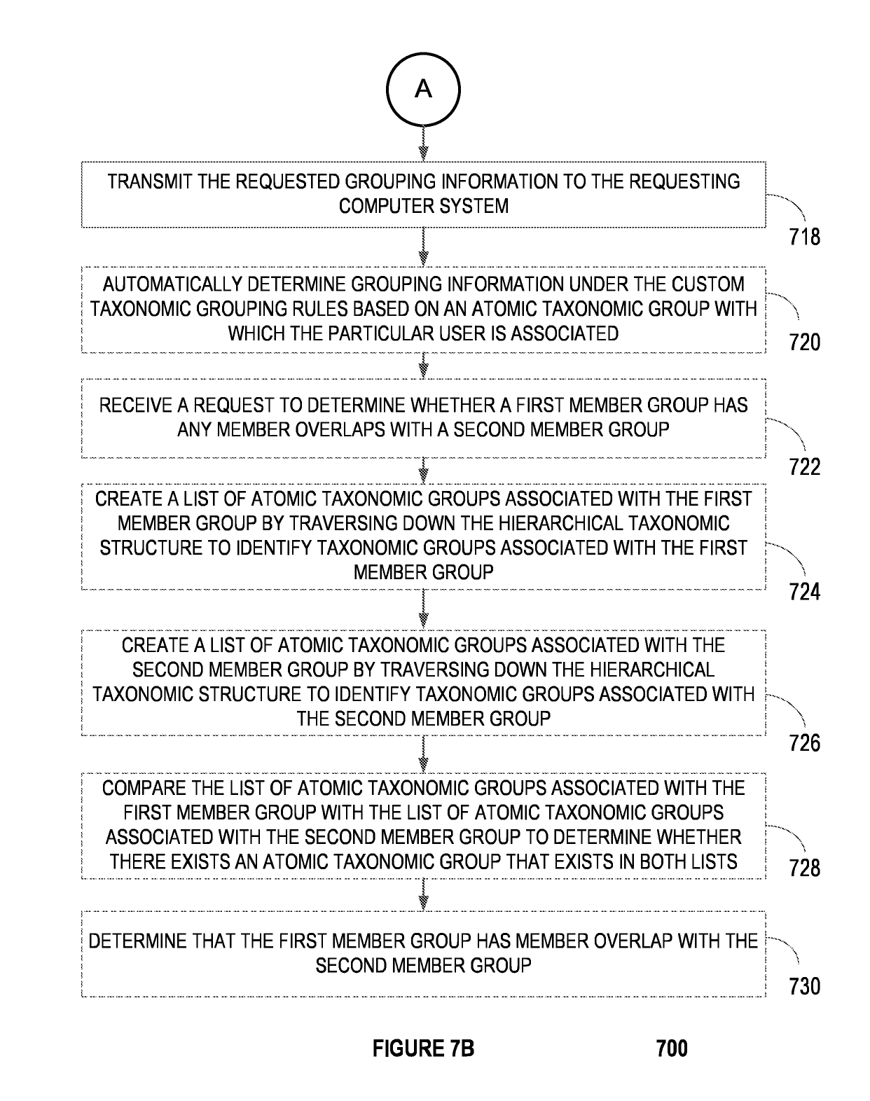

FIG. 7A is a flow diagram illustrating a method 700, in accordance with some example embodiments, for managing overlapping taxonomies in a social networking system (e.g., system 120 in FIG. 1) environment. Each of the operations shown in FIG. 7A may correspond to instructions stored in a memory 306 or a computer-readable storage medium. Optional operations are indicated by dashed lines (e.g., boxes with dashed-line borders). In some embodiments, the method 700 described in FIG. 7A is performed by the social networking system (e.g., system 120 in FIG. 1). However, the method 700 can also be performed by any other suitable configuration of electronic hardware.

In some embodiments, the method 700 is performed at a social networking system (e.g., system 120 in FIG. 1) including one or more processors and memory 306 storing one or more programs for execution by the one or more processors.

The social networking system (e.g., system 120 in FIG. 1) stores (702) a set of taxonomic grouping rules for organizing members based on stored member data, wherein the taxonomic rules define a hierarchical taxonomic structure with a plurality of atomic taxonomic groups at a first level of the hierarchy.

In some example embodiments, the atomic taxonomic groups do not have any member overlap. In some example embodiments, the atomic taxonomic groups are the lowest level in the hierarchical taxonomic structure and are created such that no member can belong to more than one atomic group. In some example embodiments, existing member data does not conveniently allow classification into appropriate atomic taxonomic groups, and in response, the atomic taxonomic groups are created by creating a tuple from two member data variables. For example, if postal codes and cities overlap such that a postal code can cover more than one city and a city, if large enough, can contain multiple postal codes, then atomic taxonomic groups can be created based on a tuple of both city and postal code.

In some example embodiments, the social networking system (e.g., system 120 in FIG. 1) receives (704) a request for grouping information for a particular member, wherein the request identifies a second level in the hierarchical taxonomic data structure for which grouping information is requested. For example, a service within the social networking system (e.g., system 120 in FIG. 1) wants to know the level of seniority of a member.

In some example embodiments, using stored member data for the particular member, the social networking system (e.g., system 120 in FIG. 1) classifies (706) the particular member into an atomic taxonomic group in the plurality of the atomic taxonomic groups.

In some example embodiments, classifying the particular member into an atomic taxonomic group in the plurality of the atomic taxonomic groups includes, for at least one atomic taxonomic group, the social networking system (e.g., system 120 in FIG. 1) generating (710) a likelihood that the member is included in the at least one taxonomic group based on stored member data.

In some example embodiments, the social networking system (e.g., system 120 in FIG. 1) selects (712) the atomic taxonomic group with the highest likelihood as the atomic taxonomic group for the particular member. For example, Member A has a 20 percent chance of being classified into Group 1, a 45 percent chance of being classified into Group 2, and a 35 percent chance of being classified into Group 3. In this example, the social networking system (e.g., system 120 in FIG. 1) selects Group 2 as the atomic taxonomic group for Member A.

In other example embodiments, the social networking system (e.g., system 120 in FIG. 1) does not select a specific atomic group, but instead provides services as though the member was grouped into each of those groups. For example, if the service is for suggesting potential contacts, the social networking system (e.g., system 120 in FIG. 1) will suggest contacts based on the member being grouped into Group 1, Group 2, and Group 3, such that the member will see contacts for each. In some example embodiments, the percentage of suggestions will be based on the likelihood that the member falls into that group. Thus, if a member only has a 10 percent chance of being grouped into Group 1, only 10 percent of the suggestions will be associated with group 1. Similarly, the social networking system (e.g., system 120 in FIG. 1) may establish a likelihood floor, such that any group that falls below the likelihood floor (e.g., below 5 percent) will not be represented in the suggestions.

In some example embodiments, the social networking system (e.g., system 120 in FIG. 1) stores (714) the likelihood for at least one atomic taxonomic group for later reference. In this way, the social networking system (e.g., system 120 in FIG. 1) retains the likelihood information for later use.

In some example embodiments, based on the atomic taxonomic group that the particular member is grouped into, the social networking system (e.g., system 120 in FIG. 1) automatically determines (716) the requested grouping information.

For example, if a request is to determine the department a particular member works in (e.g., an advertiser is seeking to target employees in the human resources departments of corporations), the social networking system (e.g., system 120 in FIG. 1) first determines the atomic grouping of the member. In this example, the member is determined to be involved in sensitivity training (e.g., the atomic grouping for the member's role). The social networking system (e.g., system 120 in FIG. 1) determines that the parent group (or node) for the sensitivity training role group is the “Training” group (e.g., the next level of the hierarchy). The social networking system (e.g., system 120 in FIG. 1) then determines that the parent node of the “Training” group is the “Human Resources Department” group. Thus, the social networking system (e.g., system 120 in FIG. 1) was able to automatically determine the department of the member based solely on the atomic grouping of the member.

FIG. 7B is a flow diagram illustrating a method 700, in accordance with some example embodiments, for managing overlapping taxonomies in a social networking system (e.g., system 120 in FIG. 1) environment. Each of the operations shown in FIG. 7B may correspond to instructions stored in a computer memory or computer-readable storage medium. Optional operations are indicated by dashed lines (e.g., boxes with dashed-line borders). In some embodiments, the method 700 described in FIG. 7B is performed by the social networking system (e.g., system 120 in FIG. 1). However, the method described can also be performed by any other suitable configuration of electronic hardware.

In some embodiments, the method 700 is performed at a social networking system (e.g., system 120 in FIG. 1) including one or more processors and memory storing one or more programs for execution by the one or more processors.

In some example embodiments, the social networking system (e.g., system 120 in FIG. 1) transmits (718) the requested grouping information to the requesting computer system.

In some example embodiments, the social networking system (e.g., system 120 in FIG. 1) receives custom taxonomic grouping rules, wherein each group in the custom taxonomic grouping rules is associated with one or more atomic taxonomic groups in the existing taxonomic rules. For example, if the current taxonomic system groups members based on the country they currently live in but a particular service needs to group members based on their languages, the social networking system (e.g., system 120 in FIG. 1) receives a request detailing the new taxonomic groupings and detailing how at least some groupings of the current taxonomic system (e.g., the atomic groupings at the very least) fit into the customized taxonomic system.

For a particular member, the social networking system (e.g., system 120 in FIG. 1) automatically determines (720) grouping information under the custom taxonomic grouping rules based on an atomic taxonomic group with which the particular member is associated. Continuing the above example, if a member is grouped into an atomic grouping for a neighborhood in Montreal, the social networking system (e.g., system 120 in FIG. 1) is able to automatically associate that neighborhood with a particular area of Montreal (its designated parent node). Each area of Montreal is then associated with another parent node, detailing which language is predominantly spoken there. Thus, the social networking system (e.g., system 120 in FIG. 1) uses the atomic grouping information, combined with the information associating the custom groupings with the existing taxonomic groups, to automatically group members without any new classifying being done.

In some example embodiments, the social networking system (e.g., system 120 in FIG. 1) receives (722) a request to determine whether a first member group has any member overlaps with a second member group.

In some example embodiments, the social networking system (e.g., system 120 in FIG. 1) creates (724) a list of atomic taxonomic groups associated with the first member group by traversing down the hierarchical taxonomic structure to identify taxonomic groups associated with the first member group. Each group in the taxonomic hierarchy has parent nodes (except for the top node) and child nodes (except for the bottommost nodes). The social networking system (e.g., system 120 in FIG. 1) selects all the child nodes of the first member group. For each child node the social networking system (e.g., system 120 in FIG. 1) iterates down the taxonomic graph by finding the child nodes of each node it accesses until it finds atomic level groups (e.g., the lowest groups in the hierarchy graph). Once the social networking system (e.g., system 120 in FIG. 1) has traversed each child node beginning from the first member group and has added all the atomic-level groups it finds to the list, the list will include all possible atomic groups that are associated with the first member group.

In some example embodiments, the social networking system (e.g., system 120 in FIG. 1) creates (726) a list of atomic taxonomic groups associated with the second member group by traversing down the hierarchical taxonomic structure to identify taxonomic groups associated with the second member group.

In some example embodiments, the social networking system (e.g., system 120 in FIG. 1) compares (728) the list of atomic taxonomic groups associated with the first member group with the list of atomic taxonomic groups associated with the second member group to determine whether there exists an atomic taxonomic group that exists in both lists.

In accordance with a determination that there exists an atomic taxonomic group that exists in both lists, the social networking system (e.g., system 120 in FIG. 1) determines (730) that the first member group has member overlap with the second member group.

### Software Architecture

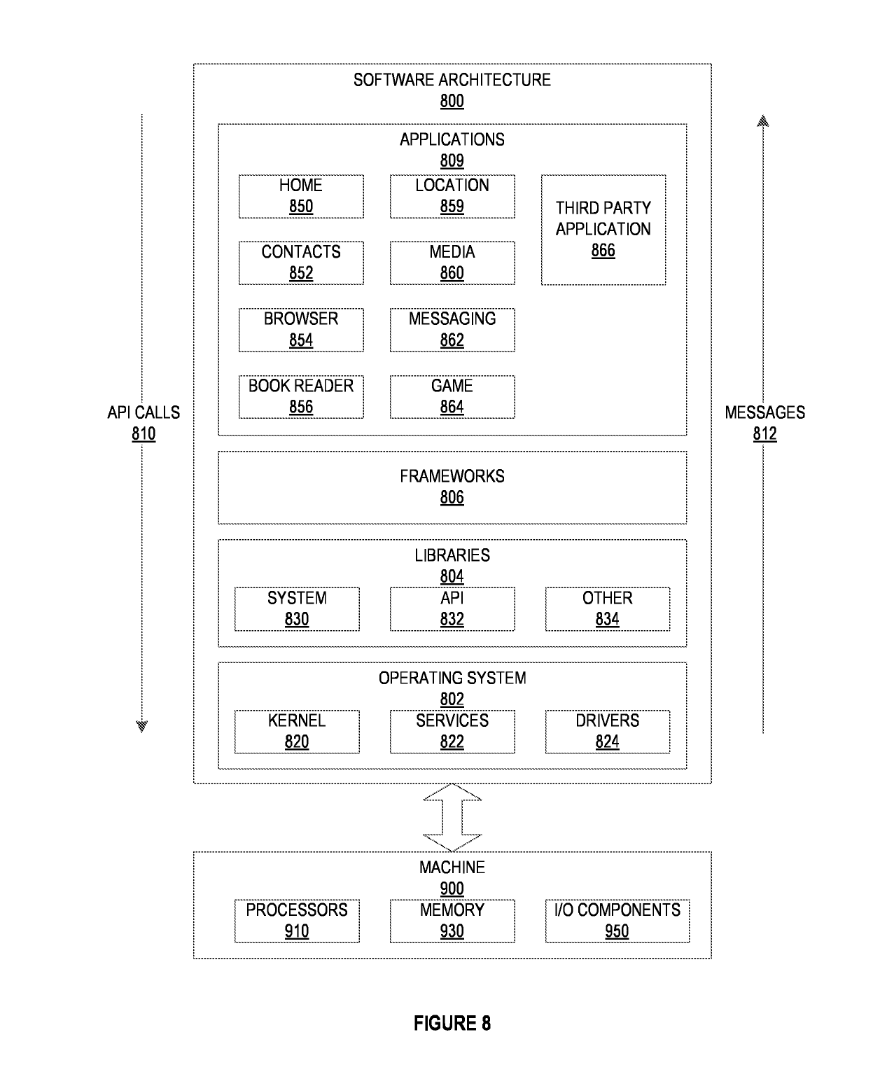

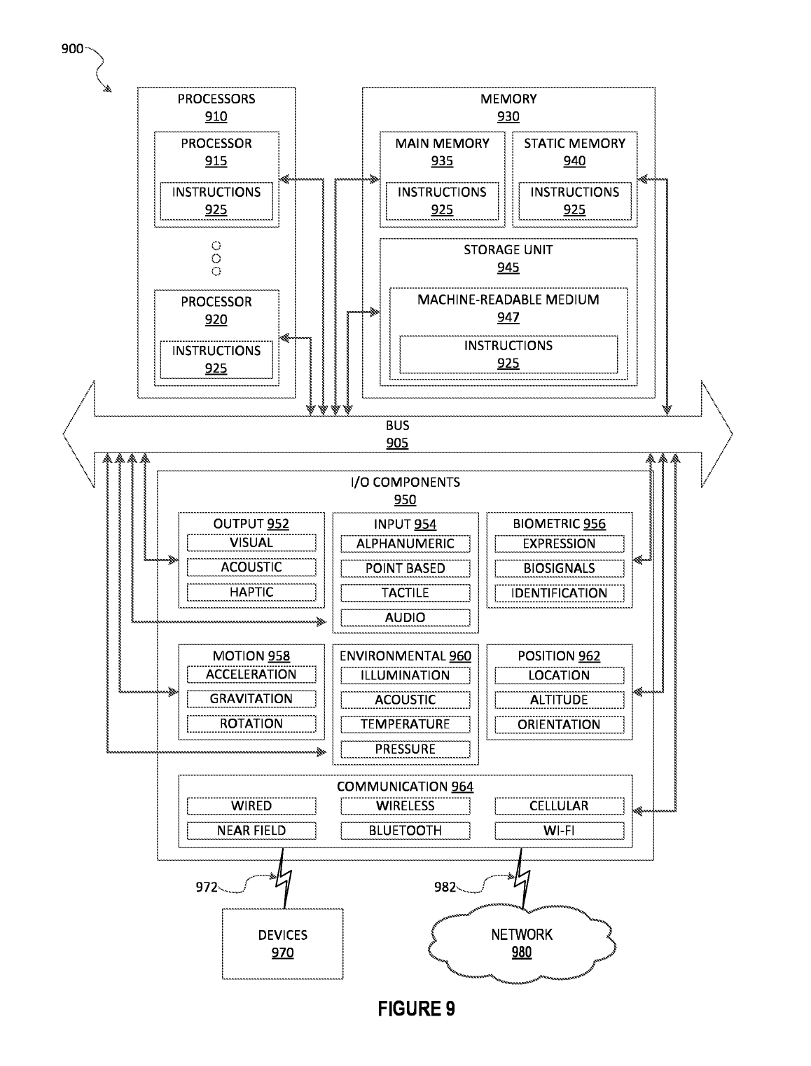

FIG. 8 is a block diagram illustrating an architecture of software 800, which may be installed on any one or more of the devices of FIG. 1. FIG. 8 is merely a non-limiting example of an architecture of software 800 and it will be appreciated that many other architectures may be implemented to facilitate the functionality described herein. The software 800 may be executing on hardware such as a machine 900 of FIG. 9 that includes processors 910, memory 930, and I/O components 950. In the example architecture of FIG. 8, the software 800 may be conceptualized as a stack of layers where each layer may provide particular functionality. For example, the software 800 may include layers such as an operating system 802, libraries 804, frameworks 806, and applications 809. Operationally, the applications 809 may invoke API calls 810 through the software stack and receive messages 812 in response to the API calls 810.

The operating system 802 may manage hardware resources and provide common services. The operating system 802 may include, for example, a kernel 820, services 822, and drivers 824. The kernel 820 may act as an abstraction layer between the hardware and the other software layers. For example, the kernel 820 may be responsible for memory management, processor management (e.g., scheduling), component management, networking, security settings, and so on. The services 822 may provide other common services for the other software layers. The drivers 824 may be responsible for controlling and/or interfacing with the underlying hardware. For instance, the drivers 824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 804 may provide a low-level common infrastructure that may be utilized by the applications 809. The libraries 804 may include system libraries 830 (e.g., C standard library) that may provide functions such as memory allocation functions, string manipulation functions, mathematic functions, and the like. In addition, the libraries 804 may include API libraries 832 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 804 may also include a wide variety of other libraries 834 to provide many other APIs to the applications 809.

The frameworks 806 may provide a high-level common infrastructure that may be utilized by the applications 809. For example, the frameworks 806 may provide various graphical user interface (GUI) functions, high-level resource management, high-level location services, and so forth. The frameworks 806 may provide a broad spectrum of other APIs that may be utilized by the applications 809, some of which may be specific to a particular operating system 802 or platform.

The applications 809 include a home application 850, a contacts application 852, a browser application 854, a book reader application 856, a location application 859, a media application 860, a messaging application 862, a game application 864, and a broad assortment of other applications such as a third party application 866. In a specific example, the third party application 866 (e.g., an application developed using the Android™ or iOS™ software development kit (SDK) by an entity other than the vendor of the particular platform) may be mobile software running on a mobile operating system 802 such as iOS™, Android™, Windows® Phone, or other mobile operating systems 802. In this example, the third party application 866 may invoke the API calls 810 provided by the mobile operating system 802 to facilitate functionality described herein.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 925 (e.g., software 800, a program, an application, an applet, an app, or other executable code) for causing the machine 900 to perform any one or more of the methodologies discussed herein may be executed. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but be not limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 925, sequentially or otherwise, that specify actions to be taken by the machine 900. Further, while only a single machine 900 is illustrated, the term “machine” shall also be taken to include a collection of machines 900 that individually or jointly execute the instructions 925 to perform any one or more of the methodologies discussed herein.

The machine 900 may include processors 910, memory 930, and I/O components 950, which may be configured to communicate with each other via a bus 905. In an example embodiment, the processors 910 (e.g., a CPU, a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, a processor 915 and a processor 920, which may execute the instructions 925. The term “processor” is intended to include multi-core processors 910 that may comprise two or more independent processors 915, 920 (also referred to as “cores”) that may execute the instructions 925 contemporaneously. Although FIG. 9 shows multiple processors 910, the machine 900 may include a single processor 910 with a single core, a single processor 910 with multiple cores (e.g., a multi-core processor), multiple processors 910 with a single core, multiple processors 910 with multiple cores, or any combination thereof.

The memory 930 may include a main memory 935, a static memory 940, and a storage unit 945 accessible to the processors 910 via the bus 905. The storage unit 945 may include a machine-readable medium 947 on which are stored the instructions 925 embodying any one or more of the methodologies or functions described herein. The instructions 925 may also reside, completely or at least partially, within the main memory 935, within the static memory 940, within at least one of the processors 910 (e.g., within the processor's cache memory), or any suitable combination thereof, during execution thereof by the machine 900. Accordingly, the main memory 935, the static memory 940, and the processors 910 may be considered machine-readable media 947.

As used herein, the term “memory” refers to a machine-readable medium 947 able to store data temporarily or permanently and may be taken to include, but not be limited to, random-access memory (RAM), read-only memory (ROM), buffer memory, flash memory, and cache memory. While the machine-readable medium 947 is shown, in an example embodiment, to be a single medium, the term “machine-readable medium” should be taken to include a single medium or multiple media (e.g., a centralized or distributed database, or associated caches and servers) able to store the instructions 925. The term “machine-readable medium” shall also be taken to include any medium, or combination of multiple media, that is capable of storing instructions (e.g., instructions 925) for execution by a machine (e.g., machine 900), such that the instructions 925, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 950 may include a wide variety of components to receive input, provide and/or produce output, transmit information, exchange information, capture measurements, and so on. It will be appreciated that the I/O components 950 may include many other components that are not shown in FIG. 9. In various example embodiments, the I/O components 950 may include output components 952 and/or input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instruments), tactile input components (e.g., a physical button, a touch screen that provides location and force of touches or touch gestures, and/or other tactile input components), audio input components (e.g., a microphone), and the like.

In further example embodiments, the I/O components 950 may include biometric components 956, motion components 958, environmental components 960, and/or position components 962, among a wide array of other components. For example, the biometric components 956 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, finger print identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e.g., infrared sensors that detect nearby objects), and/or other components that may provide indications, measurements, and/or signals corresponding to a surrounding physical environment. The position components 962 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 and/or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine 900 and/or any of a wide variety of peripheral devices (e.g., a peripheral device coupled via a USB).

Moreover, the communication components 964 may detect identifiers and/or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In addition, a variety of information may be derived via the communication components 964 such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 980 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 925 may be transmitted and/or received over the network 980 using a transmission medium via a network interface device (e.g., a network interface component included in the communication components 964) and utilizing any one of a number of well-known transfer protocols (e.g., HyperText Transfer Protocol (HTTP)). Similarly, the instructions 925 may be transmitted and/or received using a transmission medium via the coupling 972 (e.g., a peer-to-peer coupling) to the devices 970. The term “transmission medium” shall be taken to include any intangible medium that is capable of storing, encoding, or carrying the instructions 925 for execution by the machine 900, and includes digital or analog communications signals or other intangible media to facilitate communication of such software 800.

Furthermore, the machine-readable medium 947 is non-transitory (in other words, not having any transitory signals) in that it does not embody a propagating signal. However, labeling the machine-readable medium 947 as “non-transitory” should not be construed to mean that the medium is incapable of movement; the medium should be considered as being transportable from one physical location to another. Additionally, since the machine-readable medium 947 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A method comprising:
storing a set of taxonomic grouping rules for organizing members based on stored member data, wherein the taxonomic grouping rules define a hierarchical taxonomic structure with a plurality of atomic taxonomic groups at a first level of the hierarchical taxonomic structure;
receiving a request for grouping information for a particular member, wherein the request identifies a second level in the hierarchical taxonomic structure for which the grouping information is requested;
using stored member data for the particular member, classifying the particular member into an atomic taxonomic group in the plurality of the atomic taxonomic groups;
based on the atomic taxonomic group that the particular member is classified into, automatically determining the requested grouping information; and
transmitting the requested grouping information to a requesting computer system.

2. The method of claim 1, further comprising:
receiving custom taxonomic grouping rules comprising a plurality of groups, wherein each group in the custom taxonomic grouping rules is associated with one or more atomic taxonomic groups in the existing taxonomic grouping rules; and
for a particular member, automatically determining grouping information under the custom taxonomic grouping rules based on the atomic taxonomic group into which the particular member is classified.

3. The method of claim 1, wherein the atomic taxonomic groups do not have any member overlap.

4. The method of claim 1, wherein the atomic taxonomic groups are the lowest level in the hierarchical taxonomic structure.

5. The method of claim 1, wherein the atomic taxonomic groups are created by creating a tuple from two member data variables.

6. The method of claim 1, further comprising:
receiving a request to determine whether a first member group has any member overlaps with a second member group;
creating a list of atomic taxonomic groups associated with the first member group by traversing down the hierarchical taxonomic structure to identify taxonomic groups associated with the first member group;
creating a list of atomic taxonomic groups associated with the second member group by traversing down the hierarchical taxonomic structure to identify taxonomic groups associated with the second member group; and
comparing the list of atomic taxonomic groups associated with the first member group with the list of atomic taxonomic groups associated with the second member group to determine whether there exists an atomic taxonomic group that exists in both lists.

7. The method of claim 6, further comprising:
in accordance with a determination that there exists an atomic taxonomic group that exists in both lists, determining that the first member group has member overlap with the second member group.

8. The method of claim 1, in which:
classifying the particular member into an atomic taxonomic group in the plurality of the atomic taxonomic groups includes, for at least one atomic taxonomic group, generating a likelihood that the particular member is included in the at least one taxonomic group based on the stored member data.

9. The method of claim 8, further comprising selecting the atomic taxonomic group with the highest likelihood.

10. The method of claim 8, further comprising storing the likelihood for the at least one atomic taxonomic group.

11. A system comprising:
one or more processors;
memory; and
one or more programs stored in the memory, the one or more programs comprising instructions for:
storing a set of taxonomic grouping rules for organizing members based on stored member data, wherein the taxonomic grouping rules define a hierarchical taxonomic structure with a plurality of atomic taxonomic groups at a first level of the hierarchical taxonomic structure;
receiving a request for grouping information for a particular member, wherein the request identifies a second level in the hierarchical taxonomic structure for which the grouping information is requested;
using stored member data for the particular member, classifying the particular member into an atomic taxonomic group in the plurality of the atomic taxonomic groups;
based on the atomic taxonomic group that the particular member is classified into, automatically determining the requested grouping information; and
transmitting the requested grouping information to a requesting computer system.

12. The system of claim 11, further comprising:
receiving custom taxonomic grouping rules comprising a plurality of groups, wherein each group in the custom taxonomic grouping rules is associated with one or more atomic taxonomic groups in the existing taxonomic grouping rules; and
for a particular member, automatically determining grouping information under the custom taxonomic grouping rules based on the atomic taxonomic group into which the particular member is classified.

13. The system of claim 11, wherein the atomic taxonomic groups do not have any member overlap.

14. The system of claim 11, wherein the atomic taxonomic groups are the lowest level in the hierarchical taxonomic structure.

15. The system of claim 11, wherein the atomic taxonomic groups are created by creating a tuple from two member data variables.

16. A non-transitory computer readable storage medium storing one or more programs for execution by one or more processors, the one or more programs comprising instructions for:
storing a set of taxonomic grouping rules for organizing members based on stored member data, wherein the taxonomic grouping rules define a hierarchical taxonomic structure with a plurality of atomic taxonomic groups at a first level of the hierarchical taxonomic structure;
receiving a request for grouping information for a particular member, wherein the request identifies a second level in the hierarchical taxonomic structure for which the grouping information is requested;
using stored member data for the particular member, classifying the particular member into an atomic taxonomic group in the plurality of the atomic taxonomic groups;
based on the atomic taxonomic group that the particular member is classified into, automatically determining the requested grouping information; and
transmitting the requested grouping information to a requesting computer system.

17. The non-transitory computer readable storage medium of claim 16, further comprising:
receiving custom taxonomic grouping rules comprising a plurality of groups, wherein each group in the custom taxonomic grouping rules is associated with one or more atomic taxonomic groups in the existing taxonomic grouping rules; and
for a particular member, automatically determining grouping information under the custom taxonomic grouping rules based on the atomic taxonomic group into which the particular member is classified.

18. The non-transitory computer readable storage medium of claim 16, wherein the atomic taxonomic groups do not have any member overlap.

19. The non-transitory computer readable storage medium of claim 16, wherein the atomic taxonomic groups are the lowest level in the hierarchical taxonomic structure.

20. The non-transitory computer readable storage medium of claim 16, wherein the atomic taxonomic groups are created by creating a tuple from two member data variables.
